(19) United States
(12) Patent Application Publication
(10) Pub. No.: US 2010/0237100 A1
(43) Pub. Date: Sep. 23, 2010

(54) BEVERAGE STORAGE AND DISPENSING SYSTEM

(76) Inventor: Kenneth W. Broussard, Bridge City, TX (US)

Correspondence Address: Robert C. Curfiss, 19826 Sundance Drive, Humble, TX, 77346-1402, US

(21) Appl. No.: 12/408,698

(22) Filed: Mar. 21, 2009

(51) Int. Cl. B67D 7/78; B65D 83/00; B60P 3/22

(52) U.S. Cl. 222/146.6; 222/399; 222/608

(57) ABSTRACT

A beverage storage and dispensing system has a carrier designed for housing a beverage contained in a bulk container. The carrier fits in a temperature controlled box having a self-contained cooling system for maintaining the temperature in the box within a desired temperature range. A dispenser is associated with the box and adapted for communicating from the exterior of the box to the interior of the box for selectively connecting the bulk container to the dispenser system. A gas charge unit is housed in the carrier for gas charging the bulk container while it is in the box. An electrical charge system is housed with the condenser and compressor for charging a battery for operating the compressor system.

### BACKGROUND OF THE INVENTION

1. Field of the Invention

The invention generally relates to beverage storage and dispensing systems and is specifically directed to a temperature controlled mobile storage and dispensing system.

2. Discussion of the Prior Art

Beverages have long been available in individual serving size containers such as bottles and cans and in bulk containers such as cylinders and kegs. It is desirable that all beverages be maintained at or near the serving temperature to enhance the experience of the consumer. This is particularly true with beer. It is not only desirable but recommended procedure to maintain beer at a set temperature, generally around 37° F., from the point of brewing until served for consumption. This has not been possible under any of the current storage and dispensing methods.

For example, beer distributed in cans or bottles is always exposed to ambient temperature conditions during the distribution process, whether this is when delivered from the brewery, when stored at the retailer, or when purchased by the consumer. Even beer purchased in bulk containers such as kegs is exposed to ambient temperatures at some point in the distribution process. This is particularly hard on unpasteurized beer, which ages and develops undesirable odor (called skunked beer) if exposed to unrefrigerated temperatures too long.

While soft drinks are not as susceptible to temperature changes as beer, it is still desirable to minimize the number and range of temperature fluctuation during the distribution process.

Typically individual sized containers of beverages are carried from a retailer to a car and then stored at ambient temperature to be cooled down at some point before consumption. Bulk containers such as cylinders or kegs are usually exposed to ambient temperatures at some stage of the distribution process and are cooled before consumption. Often ice is used as the cooling element. This can water down the drink when added directly to the beverage, and in addition, though ice melts at one particular temperature, as water pools around it or its melting uncovers a portion of the container, it fails to provide consistent or precise temperature control. For example, when a keg is iced down in a tub, there is not any assurance that the beer in the keg is near the desired temperature of approximately 37° F.

### SUMMARY OF THE INVENTION

The subject invention is directed to a beverage storage and dispensing system that provides a mobile storage carrier for bulk beverages, while permitting maintenance of the beverage temperature to be controlled from the source of the beverage up to the point of consumption. The preferred embodiment of the invention, for around or about six keg capacity, consists of a temperature controlled, self contained cooling box with a portable beverage carrier adapted to be placed into and removed from the box. The carrier is adapted for carrying any selected number of bulk beverage containers such as, by way of example, soft drink cylinders or beer kegs. The carrier also houses a charge cylinder such as, by way of example, a CO₂ cartridge or cylinder. A smaller version of the invention, for around or about 2 kegs capacity, omits the carrier and is loaded directly through a door, but otherwise is comprised of the same features.

Where desired, the carrier may be loaded with the bulk containers directly at the source of the beverage, while at the desired temperature. The carrier may then be loaded into the cooling box, with the box already at the desired temperature. The box is then closed to ambient air and can be moved to any location. In the smaller version, the container is loaded directly with beverage that is at the desired temperature, and the door closed.

A dispensing system is an integral feature of the preferred embodiment of the invention. Each of the bulk containers is connected directly to the charge cylinder and tapped when the carrier is loaded into the cooling box. Thus, the box never has to be opened once the containers are loaded under controlled conditions.

Each container is also tapped and connected to a dispensing line. The dispensing line is connected to a dispenser manifold or tap or other dispensing assembly which is mounted directly on the outside of the cooling box. Metal feed troughs to the inside of the box help reduce the temperature of the dispensing assembly. Where desired, each dispensing line terminates at a shutoff valve. The shutoff valve is connected to a dispenser spigot and can be opened when the system reaches its destination. All components of the system upstream of the shutoff valve are always maintained in a controlled temperature environment. Only the dispenser system downstream of the shut off valve is under ambient conditions. This assures that the beverages delivered by the system of the subject invention are maintained at a desired, controlled temperature up to the moment they are dispensed for consumption.

In the preferred embodiment of the invention, the cooling box is an insulated box with an integral, rechargeable cooling system. The system is fully self-contained and once charged, does not require any outside source of power until the charge is depleted. This permits the system to be utilized at remote locations where power is not generally available, such as fairs, rodeos, parks, golf courses and the like. The system may be recharged without removing beverages that are stored therein.

The system is of a flexible design, permitting any number of containers to be stored and used, and permitting the system to be transported by a variety of means, such as, by way of example, the bed of a truck, a trailer or wagon, or even a utility vehicle or a golf cart.

### BRIEF DESCRIPTION OF THE DRAWINGS

FIG. 1 is a top diagrammatic view of a six unit assembly with the dispenser spigots mounted on the end.

FIG. 2 is a top diagrammatic view of a six unit assembly with the dispenser spigots mounted on the side.

FIG. 3 is a top diagrammatic view of a two unit assembly with the dispenser spigots mounted on the side.

FIG. 4 is a perspective view a six unit rack.

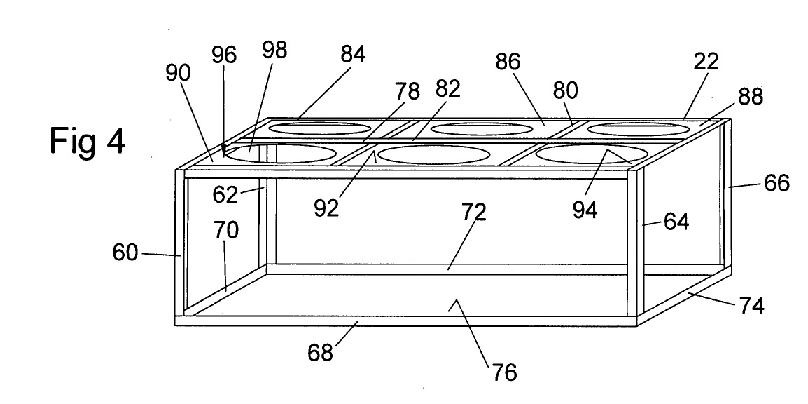

FIG. 5 is a perspective view of a cold temperature container adapted for receiving the six unit rack of FIG. 4 with the dispenser spigots mounted on the side.

FIG. 6 is a truck mounted system with the dispenser spigots mounted on the side.

FIG. 7 is a trailer or wagon mounted system with the dispenser spigots mounted at the rear of the trailer.

FIG. 8 shows a trailer mounted system with the dispenser spigots mounted at the rear, and as adapted to be towed by a golf cart or the like.

FIG. 9 is a system mounted in a utility vehicle with the dispenser spigots mounted at the rear of the vehicle.

FIG. 10 is a cut-away view of the cold temperature container for a unit assembly, looking in the direction of the cargo access opening,

FIG. 11 is a cut-away view of the cold temperature container for a unit assembly, looking in the direction from the closed end of the container.

FIG. 12 is a diagrammatic flow chart showing the manifold assembly for delivering one or more beverages to the dispenser spigots.

### DETAILED DESCRIPTION OF THE PREFERRED EMBODIMENTS

The subject invention is directed to a mobile system for maintaining beverages at a controlled temperature and dispensing the beverages into a serving container without exposing any of the stored beverages to ambient conditions. The system is ideally suited for housing one or more beer kegs but is equally well suited for housing any beverage stored in a bulk container from which individual servings are dispensed.

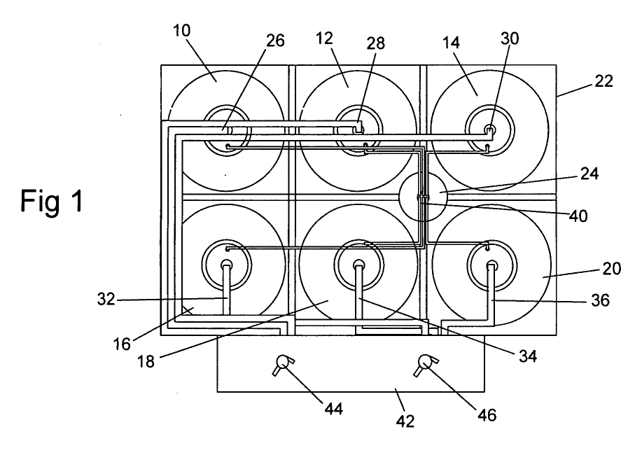

As shown in the diagrammatic view FIG. 1, a plurality of bulk beverage containers such as the six beer kegs 10, 32, 14, 18, 38 and 20 are loaded into a carrier 22. The carrier 22 also houses a charging unit such as the CO₂ cartridge 24. Each of the kegs 10, 12, 14, 16, 18 and 20 are tapped and connected to a respective dispensing line 26, 28, 30, 32, 34 and 36, in the well known manner. The kegs are also each charged by the charge cartridge 24 via a plurality of charge lines 40 in the well known manner.

Each dispensing line 10, 12, 14, 16, 18 and 20 are connected to a dispenser manifold 42 and selectively coupled to one of the dispensing spigots 44 and 46. Typically the manifold 42 is not mounted on the carrier 22 but is mounted on a side-wall of the outer box, as will be described. The dispensing lines may include a quick-connect coupler at the manifold end for quick connecting and disconnecting of the kegs to the manifold 42. This is particularly useful when the manifold 42 is mounted on the outside of the outer box.

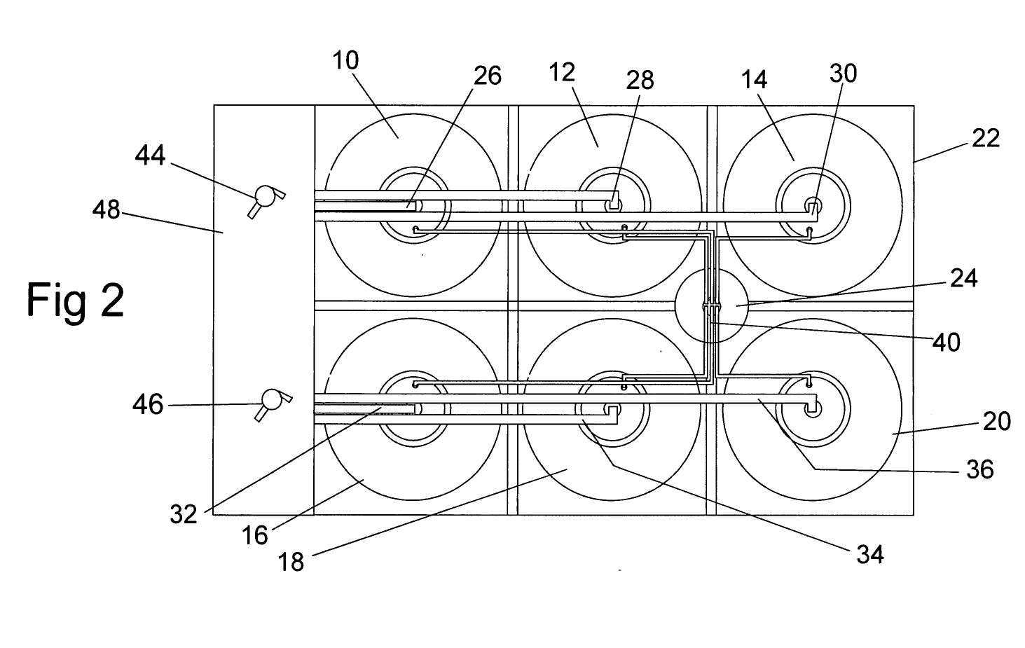

As shown in the diagrammatic view FIG. 2, the manifold 48 may be mounted on an end wall rather than on the side wall of the system. The location of the manifold and the dispenser spigots is a matter of choice, depending on application.

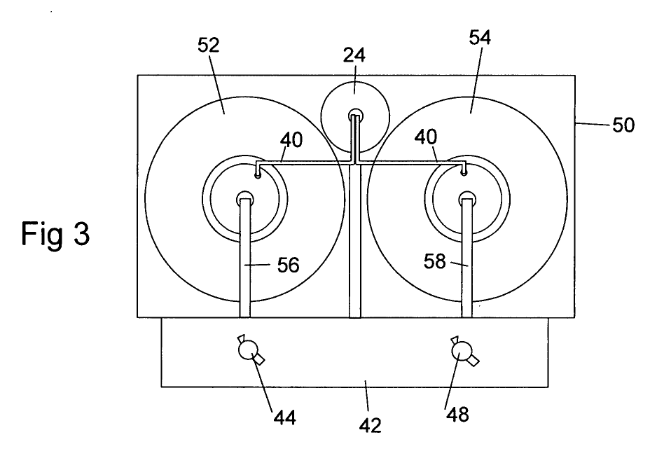

The number of beverage containers housed in the system is also a matter of choice. As shown in the diagrammatic view of FIG. 3, a two keg system includes a keg retaining base 50 adapted for housing two bulk containers or kegs 52 and 54. In this case the dispenser lines 56 and 58, respectively, may be directly connected to a specific dispensing spigot 44 and 48, respectively, rather than to a manifold assembly. The system also houses the gas charging unit 24 which is connected to the kegs vial a plurality of lines 40 in the well known manner. The gas charging unit may also be mounted outside the cold portion of the container with the condensing and battery and battery charging components, with the gas line penetrating the back insulated wall.

A perspective view of the six container or keg carrier 22 is shown in FIG. 3. The carrier is generally an open box made of upright rails 60, 62, 64 and 66 which typically will accommodate the height of the selected container or keg. The lower rail assembly 68, 70, 72 and 74 form the frame for supporting a floor 76. Grid rails 78, 80 and 82 form individual compartments 84, 86, 88, 90, 92 and 94. It is desirable, but not necessary, that each compartment be fitted with a plate 96 having an opening 98 sized to accept the selected bulk container and hold it firmly in place within the carrier. The charge cartridge 24 may be positioned at any convenient location within the carrier 22.

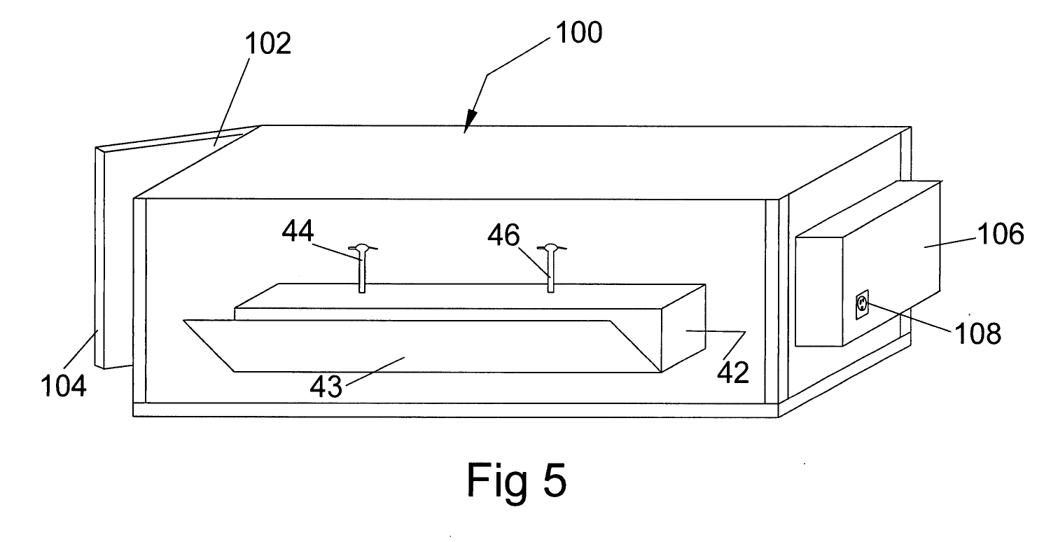

The container 22 is sized to fit snuggly within the temperature controlled outer box 100 illustrated in FIG. 5. A hinged door 102 is on one side or end of the box. This door may open to the side, or swing up or down, as desired. The hinged door will contain a weather seal 104 around its perimeter to assure sealed closure when the door is closed and latched in the well known manner. The carrier 22 is designed to slide into and out of the box 100 through the door opening. Once positioned in the box 100, the outer dimensions of the carrier closely match the inner dimensions of the box to assure minimum movement of the carrier and to minimize the amount of unused space. This enhances the efficiency of the cooling system for the box and minimizes the space required to move and store the system.

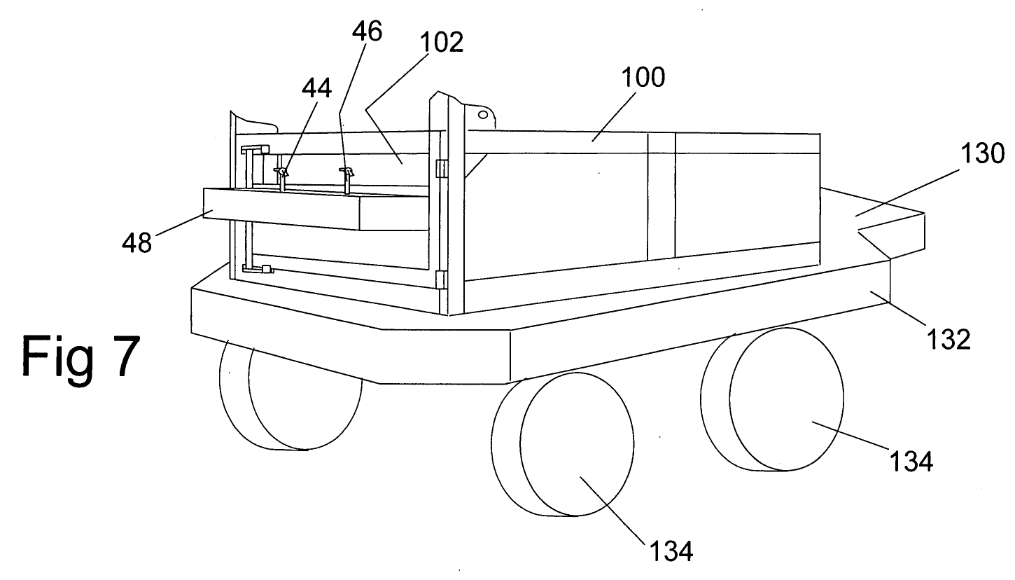

In the embodiment shown in FIG. 5, the spigot manifold 42 and dispensing spigots 44 and 46 are on sidewall of the box. This assembly could also be mounted on the door, see FIG. 7. In the preferred embodiment the manifold 42 also includes a hinged door 43 permitting access to the manifold for connecting the container dispensing lines as will be explained.

The cooling unit 106 is also mounted on a side will of the box in the embodiment of FIG. 5. The unit could be mounted on the top or underneath the box, as desired, depending on application. When the system is in use, the cooling unit is fully powered by an integral power source and does not require any power from the mobile unit or vehicle with which the system is associated. The cooling unit may be charged via the electrical charging port 108 provided on the unit box. The cooling unit provides a source of cooled, recirculating air to the inside of the box 100 for maintaining a constant temperature inside the box, assuring the bulk beverage containers are maintained at a desired temperature.

For example, beer is typically maintained at approximately 37° F. in the United States. The interior temperature of the box may be set at 37° F. and the only portion of the entire beverage path which is not entirely maintained at this temperature is the distance from the manifold to the dispenser spigot, a matter of only a few inches. Even the dispensing lines 26, 28, 30, 32, 34 and 36 are maintained in the cooled environment for there entire length, greatly improving the temperature control of the delivery system over the prior art. The specific temperature level is a matter of choice depending on application.

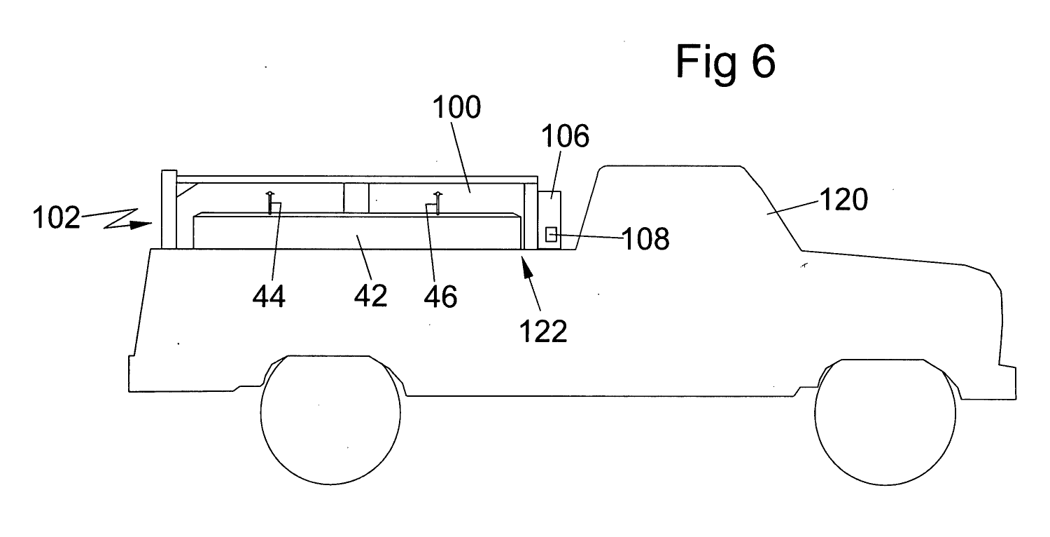

FIGS. 6, 7, 8 and 9 illustrate various mounting choices for the beverage delivery system of the subject invention. As specifically shown in FIG. 6 the box 100 and carrier 22 (not visible) may be carried on the bed of a truck. The six keg system will fit in the bed of a standard pickup truck 120. The box door 102 is at the rear of the truck bed. The carrier 22 may be inserted into and removed from the box 100 through the door 102 while the box is on the truck, or of course, when the box is removed. The electrical charging port is conveniently located so that the cooling unit may be recharged without removing the system from the truck. The manifold 42 is mounted on a side of the box 100 and just above the side wall 122 of the truck, permitting the beverages to be dispensed from the truck without any additional modifications. Where desired, the manifold assembly could be mounted at the rear of the truck, as well. The box system 100 may be loaded onto and removed from the truck bed using a standard fork lift or the like.

FIG. 7 shows a trailer or wagon mounted system wherein the outer box 102 is mounted on the bed 130 of a standard trailer 132. The trailer may be custom made to accommodate the dimensions of the box 100, or any standard trailer with sufficient weight requirements may be used. The trailer may have any number of wheels 134. A four wheeled trailer or wagon is shown because this type of unit will permit the beverage delivery system to be taken to a location and disconnected from the tow device while in use.

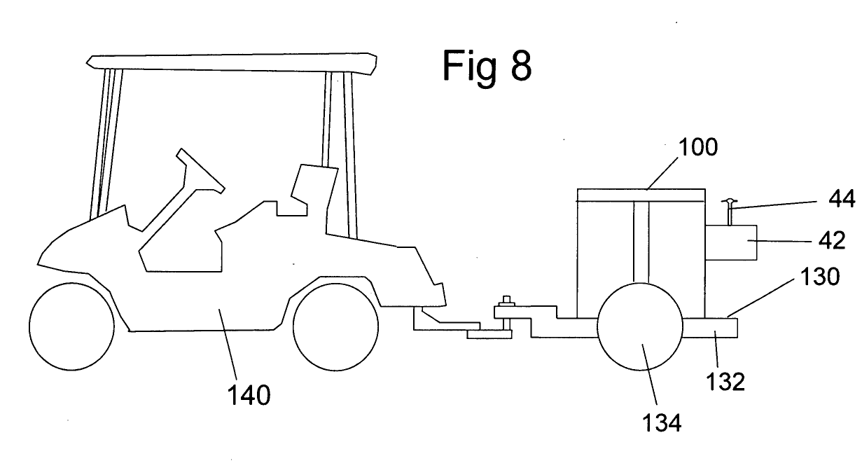

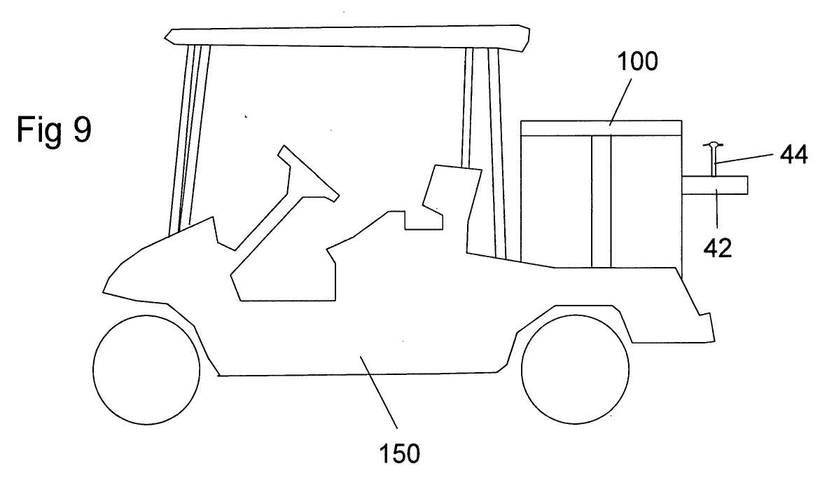

FIG. 8 shows the trailer system of FIG. 7 coupled to a tow vehicle such as the golf cart 140. The self-contained, cooled system of the subject invention is ideal for event use such as a golf tournament, fair, rodeo or the like, or for delivery of cooled drinks to golfers as they complete a round of golf.

Where desired, the beverage delivery system of the subject invention can also be mounted directly on a utility vehicle 150, as shown in FIG. 9. The vehicle may be custom made, or any vehicle with a sufficient bed size may be used. The two container system, see FIG. 3, is ideal for this application.

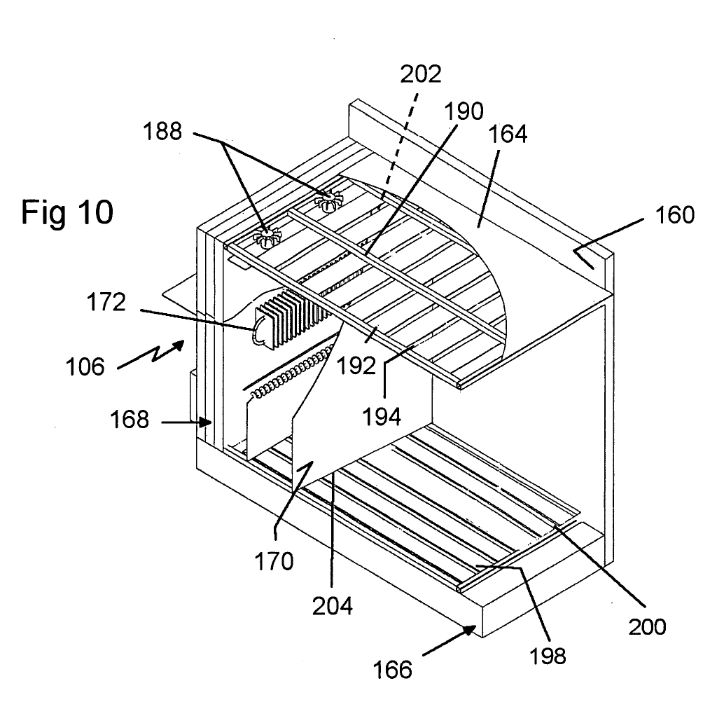

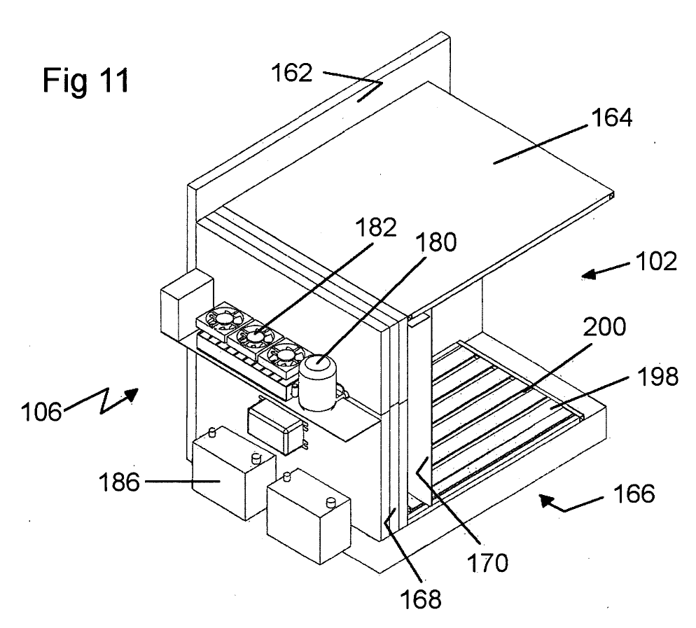

A cold box system 100 for use in connection with the carrier system such as carrier 22 is shown in the cutaway FIGS. 10 and 11. Any suitable cold box architecture may be utilized and the illustrated embodiment should be considered only as exemplary. The essential features of the cold box are that it accommodates the bulk containers, provide for a dispensing system through its walls and have a rechargeable, self-contained cooling system so that the temperature is maintained once the containers are housed therein and the access doors are closed.

The side walls 160 and 162 of the illustrated cold box are fully insulated, as are the top wall 164 and bottom wall 166. One end 103 is open and is adapted to accommodate the door 102 (See, for example, FIG. 7). The opposite end wall 168 is also fully insulated. An interior wail 170 provides a gap between the inner surface of end wall 168 and the interior of the box 100 to facilitate air flow. Alternately, a modular cooling unit which includes a shorter version of this wall as part of its structure may be inserted through an opening in the back, against which it seals both on the inside and the outside of the box. As is best shown in FIG. 11, a cooling system is mounted on end wall 168 on the exterior of the box. The cooling system comprises a compressor 180, motorized exterior fans 182 for circulating air over the condenser coils 184, and a rechargeable power supply such as the battery array 186. Motorized fans 188 are located in the top of the box between walls 168 and 170 for enhancing air circulation (See FIG. 10). Evaporator fins 172 are provided in this space as well. In the modular version the fans and coils and compressor the portion of the back wall insulation that occupies the back wall penetration needed by the cooling module are all built into the module as a unitized construction.

As is best seen in FIG. 10, the inside top wall of the box contains elongated rails 190 upon which are mounted a series of plates 192 with gaps 194 therebetween to enhance air flow from the forced air provided by the fans 188. Where the modular cooling system is employed, these are replaced by open space, with air flow guides on the back of the inner container directing air flow over the top of the payload. The floor 196 of the box is made up of flat aluminum rubbing plates for the carrier, with the gap created between those plates and the bottom of the payload created by the carrier forklift tunnels providing a return air path. The top edge 202 and the bottom edge 204 of the inner wall 170 terminate at the plates 192 and 198, respectively, thereby providing an open airflow space with the gaps 194 and 200. This system provides an integrated, fully enclosed, self-contained cooling system for the box 100. The power supply, such as battery array 186, may be recharged on an as needed basis. However, the system is fully self-powered and self-contained between charges.

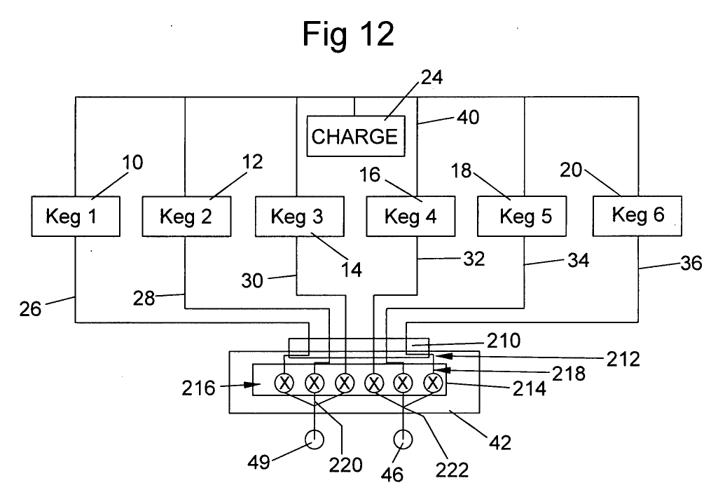

A system diagram for the dispensing manifold and spigot system is illustrated in FIG. 12. Each of the hulk containers such as kegs 10, 12, 14, 16, 18 and 20 are connected to a dispensing line 26, 28, 30, 32, 43 and 36, respectively. Each dispensing line terminated at a quick connect/disconnect block 210 which is mounted on the interior sidewall of the temperature controlled box (not shown). A plurality of manifold distribution lines 212 are connected in one-to-one relationship with the dispensing lines at the block 210. The distribution lines terminate at a series of valves 216 and 218 inside the manifold assembly 214. Valves 216 are connected to distribution lines which are coupled to kegs 10, 12 and 14. Valves 218 are connected to distribution lines which are coupled to kegs 16, 18 and 20. The other side of each of the valves 216 is connected to spigot line 220, which is coupled to spigot 44. The other side of each of the valves 218 is connected to spigot line 222 which is coupled to spigot 46. Each of the various valves 216 and 218 may be selectively opened and closed depending on which of the various bulk containers is to be tapped.

Other dispensing arrangements may be made without departing from the scope and spirit of the invention. For example, the two container system of FIG. 3 will not require manifold distribution for a two spigot dispenser. Additional spigots and support manifold assemblies may be utilized when additional varieties of beverages are carried in the carrier system. This provides flexibility in the number of containers carried and the variety of beverages carried in the system. For example, the system would permit both standard and light beers to be dispensed, or a variety of soft drinks, or a mixture of soft drinks and beer.

While certain features and embodiments of the invention have been described in detail herein, it should be understood that the invention encompasses all modifications and enhancements within the scope and spirit of the following claims.

What is claimed is:

1. A beverage storage and dispensing system comprising:
a. a carrier for housing a beverage contained in a bulk container;
b. a temperature controlled box adapted to receive the carrier and bulk container; and
c. a dispenser system associated with the box and adapted for communicating from the exterior of the box to the interior of the box; and
d. a beverage distribution system associated with the carrier and adapted to be selectively coupled to the bulk container and to the dispenser system for delivering the beverage to the dispenser system.

2. The beverage storage and dispensing system of claim 1, further including a self-contained cooling unit associated with the box for maintaining the temperature in the box within a selected range.

3. The beverage storage and dispensing system of claim 2, wherein the self-contained cooling unit includes a rechargeable power supply.

4. The beverage storage and dispensing system of claim 3, wherein the temperature in the box is maintained at approximately 37° F.

5. The beverage storage and dispensing system of claim 1, further including a gas charge unit in the carrier and a charge distribution system for charging the bulk container while it is in the box.

6. The beverage storage and dispensing system of claim 5, wherein the gas charge unit is a CO₂ cylinder.

7. The beverage storage and dispensing system of claim 1, wherein the carrier or fixed restraint, included in the beverage container, is adapted to snuggly lit in the box.

8. The beverage storage and dispensing system of claim 2, the self-contained cooling unit including a forced air circulating system for maintaining a flow of air throughout the box.

9. The beverage storage and dispensing system of claim 1, wherein the carrier is adapted for carrying multiple containers.

10. The beverage storage and dispensing system of claim 9, wherein the carrier or fixed restraint is adapted for carrying two beer kegs.

11. The beverage storage and dispensing system of claim 9, wherein the carrier or fixed restraint is adapted for carrying six beer kegs.

12. The beverage storage and dispensing system of claim 1, wherein the dispenser system is mounted on the box.

13. The beverage storage and dispensing system, wherein the dispenser system includes a manifold for selectively coupling and uncoupling the container from the dispenser system.

14. A portable beverage storage and dispensing system adapted to moved from one location to another, the system comprising:
a. a portable carrier for housing a plurality of bulk beverage containers;
b. a portable temperature controlled box adapted to receive the carrier and the bulk beverage containers; and
c. a dispenser system mounted on the box and adapted for communicating from the exterior of the box to the interior of the box; and
d. a beverage distribution system associated with the carrier and adapted to be selectively coupled to the bulk beverage containers and to the dispenser system for delivering the beverage to the dispenser system.

15. The portable beverage storage and dispensing system of claim 14, further including a manifold associated with the dispenser system for selectively coupling selected bulk beverage containers to the dispenser system.

16. The portable beverage storage and dispensing system of claim 14, wherein the carrier or fixed restraint is adapted for carrying six beer kegs and the box may be loaded onto a standard pickup truck.

17. The portable beverage storage and dispensing system of claim 14, wherein the carrier or fixed restraint is adapted for carrying two beer kegs and the box may be mounted on a trailer suitable for towing by a golf cart.

18. A beverage storage and dispensing system comprising:
a. a restraint for securing a beverage contained in a bulk container;
b. a temperature controlled box adapted to receive the restraint and bulk container; and
c. a dispenser system associated with the box and adapted for communicating from the exterior of the box to the interior of the box; and
d. a beverage distribution system associated with the restraint and adapted to be selectively coupled to the bulk container and to the dispenser system for delivering the beverage to the dispenser system.
